(19) United States
(12) Patent Application Publication
(10) Pub. No.: US 2016/0357878 A1
(43) Pub. Date: Dec. 8, 2016

(54) MODELLING METHOD AND SYSTEM

(71) Applicant: Siemens Product Lifecycle Management Software Inc., Plano, TX (US)

(72) Inventors: Howard Charles Duncan Mattson, Cambridge (GB); Douglas Joseph King, Peterborough (GB); Yanong Zhu, Cambridge (GB)

(21) Appl. No.: 14/731,985

(22) Filed: Jun. 5, 2015

(51) Int. Cl. G06F 17/50

(52) U.S. Cl. CPC G06F 17/50

(57) ABSTRACT

A method includes defining a group of control points representing the freeform geometry, defining an initial baseline between a start point and an end point of the freeform geometry and deriving an initial set of parameters for each control point to represent an initial location of the control point relative to the initial baseline. The method includes choosing a new start point and a new end point for a modified freeform geometry, defining a new baseline between the new start point and the new endpoint; applying a modification to the freeform geometry, deriving a recalculated set of parameters for each of the control points to provide a representation of a new location of the control point, relative to the new baseline, for the applied modification and rendering the modified freeform geometry using the recalculated set of parameters.

### TECHNICAL FIELD

This present disclosure relates to the general field of computer aided design, drafting (“CAD”), manufacturing (“CAM”) and visualisation systems (individually and collectively “CAD systems”), product lifecycle management (“PLM”) systems, and similar systems, that manage data for products and other items (collectively, “Product Data Management” systems or PDM systems).

### BACKGROUND OF THE DISCLOSURE

PDM systems manage PLM and other data. Improved methods and systems are desirable.

### SUMMARY OF THE DISCLOSURE

Various disclosed embodiments include methods for modifying a freeform geometry in a modelling system, or simulating modifications to construction of a multi-part product.

A method includes defining a group of control points representing the freeform geometry, defining an initial baseline between a start point and an end point of the freeform geometry and deriving an initial set of parameters for each control point to represent an initial location of the control point relative to the initial baseline. The method includes choosing a new start point and a new end point for a modified freeform geometry, defining a new baseline between the new start point and the new endpoint; applying a modification to the freeform geometry, deriving a recalculated set of parameters for each of the control points to provide a representation of a new location of the control point, relative to the new baseline, for the applied modification and rendering the modified freeform geometry using the recalculated set of parameters.

A method includes modelling the product using a model, selecting one part of the multi-part product including a freeform geometry; defining a group of control points representing the freeform geometry; defining an initial baseline between a start point and an end point of the freeform geometry; and deriving an initial set of parameters for each control point to represent an initial location of the control point relative to the initial baseline. The method includes choosing a new start point and a new end point for a modified freeform geometry, defining a new baseline between the new start point and the new endpoint; applying a modification to the freeform geometry, deriving a recalculated set of parameters for each of the control points to provide a representation of a new location of the control point, relative to the new baseline, for the applied modification, rendering the modified freeform geometry using the recalculated set of parameters and providing a representation of the modified product.

A non-transitory computer-readable medium may be encoded with executable instructions that, when executed, cause one or more data processing systems to perform a method of modifying a freeform geometry in a modelling system including defining a group of control points representing the freeform geometry; defining an initial baseline between a start point and an end point of the freeform geometry; deriving an initial set of parameters for each control point to represent an initial location of the control point relative to the initial baseline; choosing a new start point and a new end point for a modified freeform geometry; defining a new baseline between the new start point and the new endpoint; applying a modification to the freeform geometry; deriving a recalculated set of parameters for each of the control points to provide a representation of a new location of the control point, relative to the new baseline, for the applied modification; and, rendering the modified freeform geometry using the recalculated set of parameters.

A method of simulating modifications to construction of a multi-part product may include modelling the product using a model; selecting one part of the multi-part product including a freeform geometry; defining a group of control points representing the freeform geometry; defining an initial baseline between a start point and an end point of the freeform geometry; deriving an initial set of parameters for each control point to represent an initial location of the control point relative to the initial baseline; choosing a new start point and a new end point for a modified freeform geometry; defining a new baseline between the new start point and the new endpoint; applying a modification to the freeform geometry; deriving a recalculated set of parameters for each of the control points to provide a representation of a new location of the control point, relative to the new baseline, for the applied modification; rendering the modified freeform geometry using the recalculated set of parameters; and, providing a representation of the modified product.

The foregoing has outlined rather broadly the features and technical advantages of the present disclosure so that those skilled in the art may better understand the detailed description that follows. Additional features and advantages of the disclosure will be described hereinafter that form the subject of the claims. Those skilled in the art will appreciate that they may readily use the conception and the specific embodiment disclosed as a basis for modifying or designing other structures for carrying out the same purposes of the present disclosure. Those skilled in the art will also realize that such equivalent constructions do not depart from the scope of the disclosure in its broadest form.

Before undertaking the DETAILED DESCRIPTION below, it may be advantageous to set forth definitions of certain words or phrases used throughout this patent document: the terms “include” and “comprise,” as well as derivatives thereof, mean inclusion without limitation; the term “or” is inclusive, meaning and/or; and the term “controller” means any device, system or part thereof that controls at least one operation, whether such a device is implemented in hardware, firmware, software or some combination of at least two of the same. It should be noted that the functionality associated with any particular controller may be centralized or distributed, whether locally or remotely. Definitions for certain words and phrases are provided throughout this patent document, and those of ordinary skill in the art will understand that such definitions apply in many, if not most, instances to prior as well as future uses of such defined words and phrases. While some terms may include a wide variety of embodiments, the appended claims may expressly limit these terms to specific embodiments.

### BRIEF DESCRIPTION OF THE DRAWINGS

An example of method and system according to the present disclosure will now be described with reference to the accompanying drawings in which:

FIG. 1 is a block diagram of a data processing system in which an embodiment can be implemented;

FIG. 2a illustrates an example of a 2d freeform geometry to which the method of the present disclosure may be applied;

FIG. 2b illustrates an example of a 3d freeform geometry to which the method of the present disclosure may be applied;

FIG. 3 illustrates a step in a method of applying a modification to the example of FIG. 2;

FIG. 4 compares the freeform geometry of FIG. 2 with a freeform geometry modified in accordance with an embodiment of the method of the present disclosure;

FIGS. 5a and 5b illustrate applying the method according to the present disclosure with different amounts of modification.

FIG. 6 shows the effect of applying rotation in an embodiment of an exemplary method of the present disclosure;

FIG. 7 illustrates one embodiment applying rotation and stretching in a method of the present disclosure;

FIGS. 8a and 8b illustrate certain undesirable effects of scaling applied to a freeform geometry;

FIGS. 9a and 9b illustrate how the method in accordance with the disclosed embodiments may be modified to avoid the effects illustrated in FIG. 8b;

FIG. 10 illustrates a more complex geometry to which a method in accordance with the disclosed embodiments may be applied;

FIGS. 11a to 11c illustrate how a method in accordance with the disclosed embodiments may be applied to the geometry of FIG. 10;

FIGS. 12a to 12c illustrate an alternative example of applying a method in accordance with the disclosed embodiments;

FIGS. 13a to 13c illustrate a further alternative example of applying a method in accordance with the disclosed embodiments;

FIG. 14 illustrates a further example, in which the method of the present disclosure is applied; and,

FIG. 15 is a flow diagram of a process in accordance with disclosed embodiments.

### DETAILED DESCRIPTION

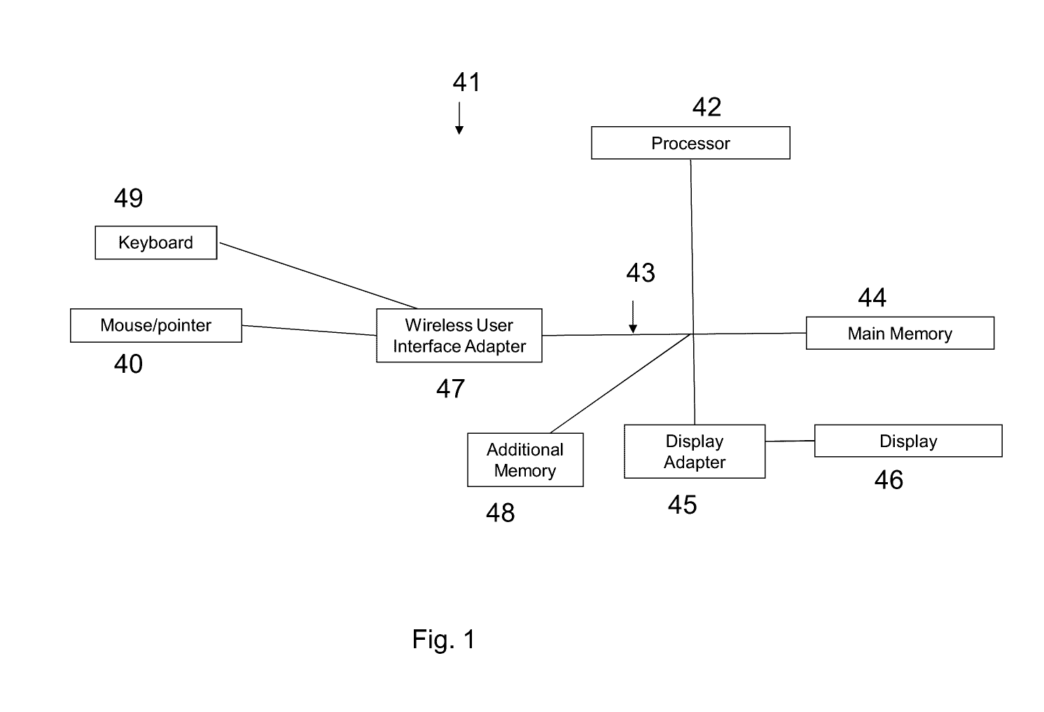

The embodiments of FIGS. 1 to 15 used to describe the principles of the present disclosure in this document are by way of illustration only and should not be construed in any way to limit the scope of the disclosure. Those skilled in the art will understand that the principles of the present disclosure may be implemented in any suitably arranged device, apparatus, system, or method.

In CAD systems, a user may wish to model a design for an object, carry out tests to determine the behaviour of that object and modify the design in response to the outcome of the tests. Direct modelling, or variational direct modelling may be used in any case where an object or article is represented as a geometric form, including machine parts, vehicles, equipment installations, building layouts, engineering structures, or chemical structures, but the disclosure is not limited to these applications. A three dimensional model allows mass, or weight of parts to be derived and interaction with other components in other systems can be determined A variational direct modelling system describes the parameters of and relationships between features in an object model in terms of geometric constraints and dimensions. Such systems then use a solver process to process these constraints and dimensions, along with a multitude of ancillary constraints and dimensions required to maintain design intent, and the entire model is solved simultaneously.

This disclosure describes how a variational direct modelling system may handle models containing freeform geometry, so as to simultaneously localise change and preserve overall freeform geometric character, as well as maintaining important end conditions.

A freeform geometry is one having an irregular or asymmetric shape or design. Among many applications of freefrom geometry, it is particularly applicable to architecture or design, such as for consumer goods.

FIG. 1 illustrates an example of a data processing system in which an embodiment of the present disclosure may be implemented, for example a CAD system configured to perform processes as described herein. The data processing system 41 comprises a processor 42 connected to a local system bus 43. The local system bus connects the processor to a main memory 44 and graphics display adaptor 45, which may be connected to a display 46. The data processing system may communicate with other systems via a wireless user interface adapter connected to the local system bus 43, or via a wired network, e.g. to a local area network. Additional memory 48 may also be connected via the local system bus. A suitable adaptor, such as Wireless User Interface Adapter 47, for other peripheral devices, such as a keyboard 49 and mouse 40, or other pointing device, allows the user to provide input to the data processing system. Other peripheral devices may include one or more I/O controllers such as USB controllers, Bluetooth controllers, and/or dedicated audio controllers (connected to speakers and/or microphones). It should also be appreciated that various peripherals may be connected to the USB controller (via various USB ports) including input devices (e.g., keyboard, mouse, touch screen, trackball, camera, microphone, scanners), output devices (e.g., printers, speakers), or any other type of device that is operative to provide inputs or receive outputs from the data processing system. Further it should be appreciated that many devices referred to as input devices or output devices may both provide inputs and receive outputs of communications with the data processing system. Further it should be appreciated that other peripheral hardware connected to the I/O controllers may include any type of device, machine, or component that is configured to communicate with a data processing system. Further, systems may use other types of input devices to provide inputs for manipulating objects such as a mouse, pointer, touch pad, drawing tablet, track ball, joystick, keypad, keyboard, camera, motion sensing device that captures motion gestures, or any other type of input device capable of providing the inputs described herein

An operating system included in the data processing system enables an output from the system to be displayed to the user on display 46 and the user to interact with the system. Examples of operating systems that may be used in a data processing system may include Microsoft Windows™, Linux™, UNIX™, iOS™, and Android™ operating systems.

In addition, it should be appreciated that data processing system 41 may be implemented as in a networked environment, distributed system environment, virtual machines in a virtual machine architecture, and/or cloud environment. For example, the processor 42 and associated components may correspond to a virtual machine executing in a virtual machine environment of one or more servers. Examples of virtual machine architectures include VMware ESCi, Microsoft Hyper-V, Xen, and KVM.

Those of ordinary skill in the art will appreciate that the hardware depicted for the data processing system 41 may vary for particular implementations. For example the data processing system 41 in this example may correspond to a computer, workstation, and/or a server. However, it should be appreciated that alternative embodiments of a data processing system may be configured with corresponding or alternative components such as in the form of a mobile phone, tablet, controller board or any other system that is operative to process data and carry out functionality and features described herein associated with the operation of a data processing system, computer, processor, and/or a controller discussed herein. The depicted example is provided for the purpose of explanation only and is not meant to imply architectural limitations with respect to the present disclosure.

The data processing system 41 may be connected to the network (not a part of data processing system 41), which can be any public or private data processing system network or combination of networks, as known to those of skill in the art, including the Internet. Data processing system 41 can communicate over the network with one or more other data processing systems such as a server (also not part of the data processing system 41). However, an alternative data processing system may correspond to a plurality of data processing systems implemented as part of a distributed system in which processors associated with several data processing systems may be in communication by way of one or more network connections and may collectively perform tasks described as being performed by a single data processing system. Thus, it is to be understood that when referring to a data processing system, such a system may be implemented across several data processing systems organized in a distributed system in communication with each other via a network.

In a variational system it is desirable to localise change, while maintaining geometric character. For analytic geometry, such as lines, circles, planes, cylinders etc, the geometric character is a given. However, when dealing with freeform geometry controlled by an unbounded number of control points, there are an unlimited number of ways in which to modify the form. The disclosure describes embodiments which balance the change so as to localise the impact on surrounding geometry while maintaining as far as possible the overall character of the geometry itself.

One embodiment of the method is explained with reference to an example freeform geometry 1 shown in FIG. 2a and an endpoint 2 to be dragged. The example geometry is a 2d representation, but the method as described herein is equally applicable to 3d non-planar curves, for example of the type as shown in FIG. 2b, or 3d surfaces. However, for such cases, there is another dimension to lock, as described in more detail hereinafter. For the 2d example, control points, p 3 are indicated in FIG. 2a. The number of control points is unbounded. A contraction of the unbounded number of control points 3, and so variables, into a simple parameterisation, is made. Further detail is shown in FIG. 3. A baseline, b 4 is defined as the line segment between a start point 5 and an end point 2 of the geometry. Each control point p is parameterised according to its relative position x along the baseline and its absolute perpendicular distance y above, or below, the baseline. Thus, the contraction is achieved by applying a single scale factor in the x direction, so all control points are all linked through this, preserving the shape character whilst also allowing a stretch to be applied. For a 2d representation, the y distance perpendicular from the baseline is locked and does not change when the new control points for the new freeform geometry are calculated. For a 3d curve there is another distance z, which is also locked, as indicated in FIG. 2b. The z distance is perpendicular to the baseline and also perpendicular to the y distance. The y distance is perpendicular to the baseline. An example of a 3d curve 26 can be seen in FIG. 2b.

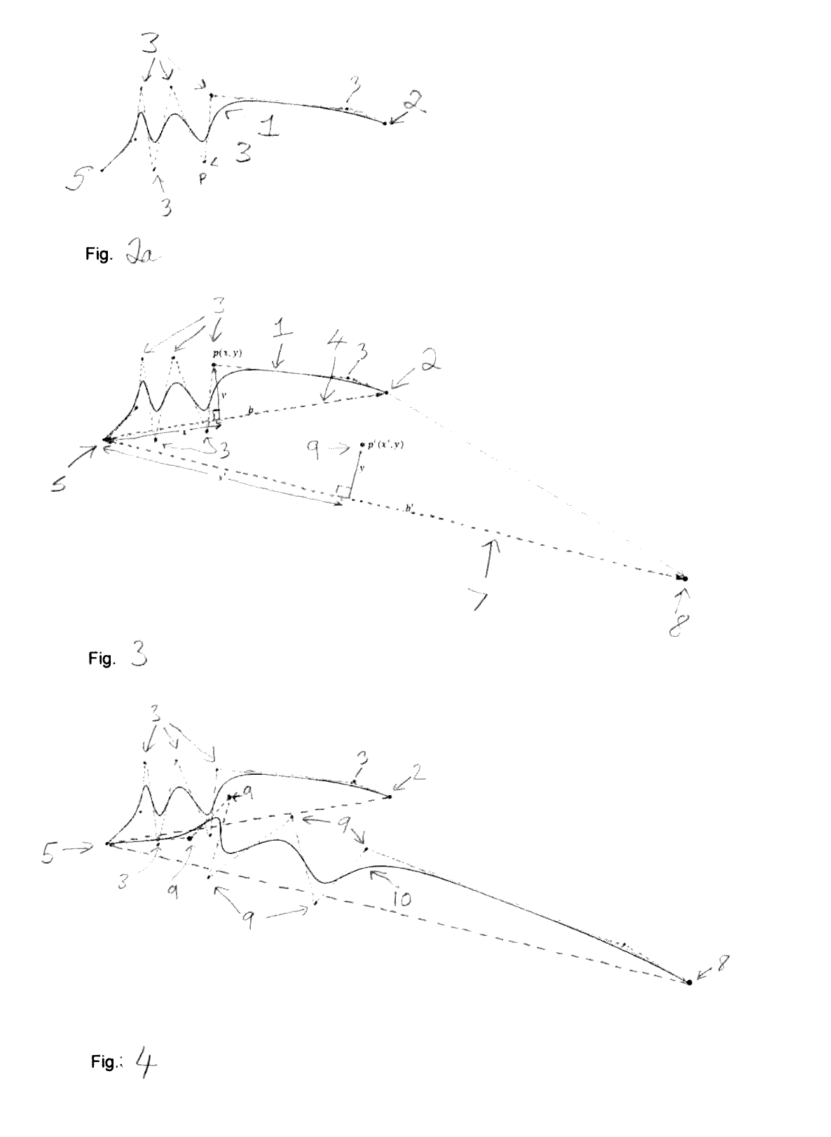

Given a new start point and new end point, a new baseline, b′ 7 is defined between the start point 5 and new end point 8 and each new control point p′ 9 is calculated at the same relative position x′ along the new baseline 7, i.e. x′/b′=x/b and at the same absolute perpendicular distance y above, or below, the new baseline. For a 3d curve, the perpendicular to the 3d curve is kept consistent between the initial baseline and the new baseline, so that the curve retains its character. The new start point may not actually be different to the original start point. Quite often, a change to a freeform geometry is made by moving only one end of the geometry, or even in some cases, keeping both ends fixed, but moving an intermediate control point to apply a modification to the geometry. The example of FIG. 4 shows the calculation of a control point 9 of the new freeform geometry when the left hand end remains fixed at start point 5 and the right hand end has been dragged to a new location 8. The resulting geometry 10 formed by applying this procedure to all the control points 3 is shown in FIG. 4.

Alternatively, the start point 5 may also be moved to a new start point 27 and the new geometric form 29 derived, for example as described with respect to FIG. 14 below. As the new geometric form is completely determined from the original geometry and the new start and end points 27, 28, no additional complication is added in this example, as compared to keeping the same start point as the original geometry. The change has the character of a constant height stretch to fit between start and end points, wherever they may be. A unique solution exists for all start and end points and the overall ‘feel’ is one of stretch and rotate. In another example, both the start point and end point may be fixed and one of the intermediate control points is moved to apply the modification, as described in more detail below.

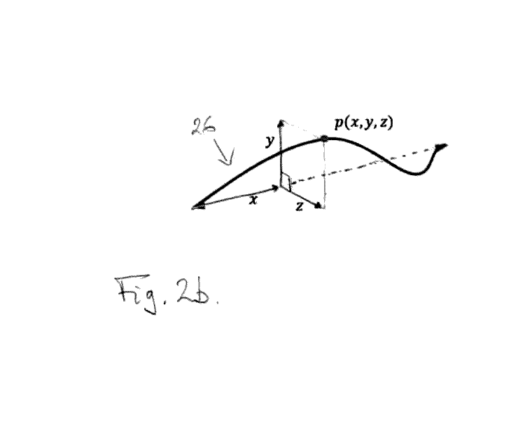

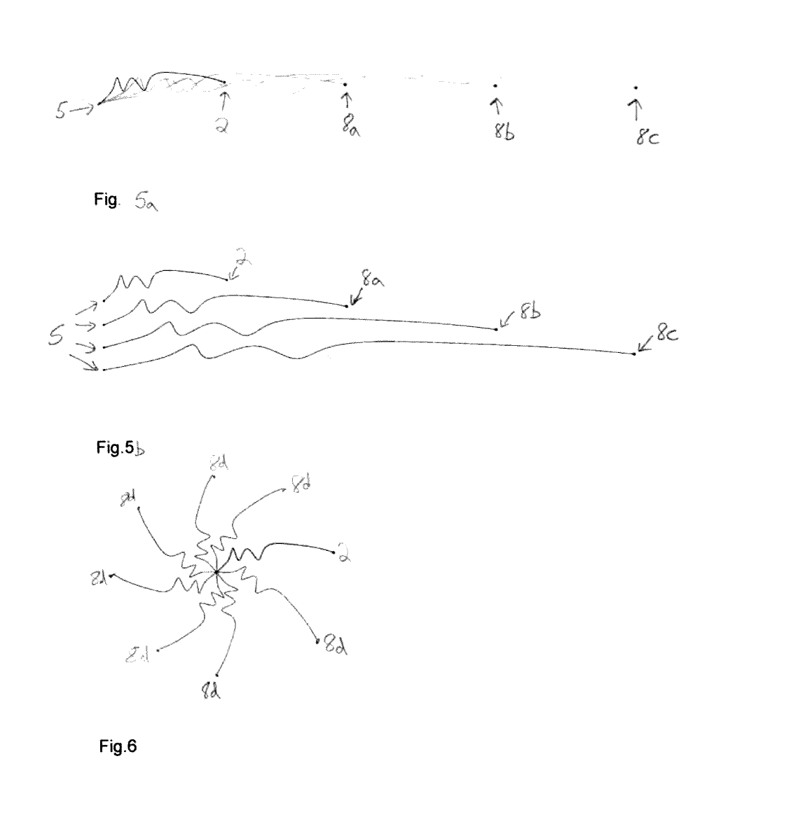

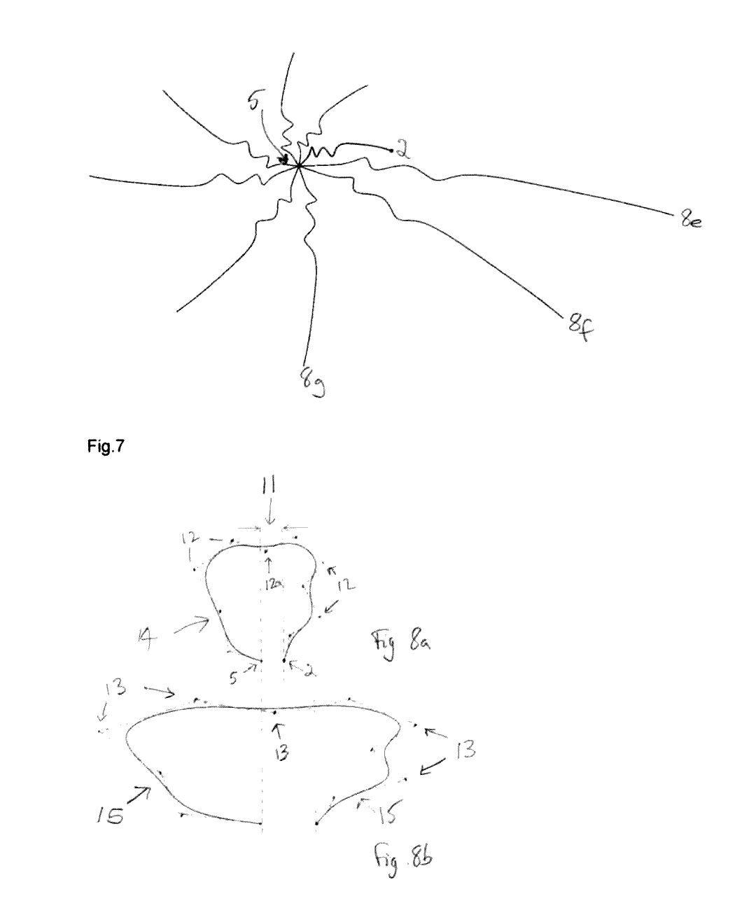

FIGS. 5a and 5b illustrate in more detail, the stretch behaviour resulting from moving the end point 2 away from the start point 5, producing a series of end points, each of these three new endpoints 8a, 8b, 8c being at different distances from the start point. In FIG. 5b, the results are shown separated for clarity. FIG. 6 illustrates the effect of moving the end point 2 around, so that each of the series of new end points 8d is at a constant distance from the start point. This produces a rotate behaviour. Moving the end point 2 away from and around the start point 5 produces a combined stretch and rotate behaviour as illustrated by the geometries shown in FIG. 7, for example, with new end points 8e, 8f, 8g. In each case the overall character of the original freeform geometry 1 is clearly maintained.

In the event that there are control points in the original freeform geometry which project onto the baseline 11 outside a range of locations defined between the start point 5 and end point 2, it is necessary to make an adjustment for these out of range control points. Without an adjustment, the control points that project onto the baseline outside the start-end region will also be scaled, producing a result which no longer maintains the overall character of the freeform geometry. An example of this can be seen in FIGS. 8a and 8b. A freeform geometry 14 has start point 5 and end point 2, but has only one control point 12a within the baseline range 11. All other control points 12 are outside the baseline range. Applying scaling to the points outside the baseline results in a geometry 15 with scaled control points 13, as shown in FIG. 8b. This has not maintained the overall character of the original geometry in FIG. 8a.

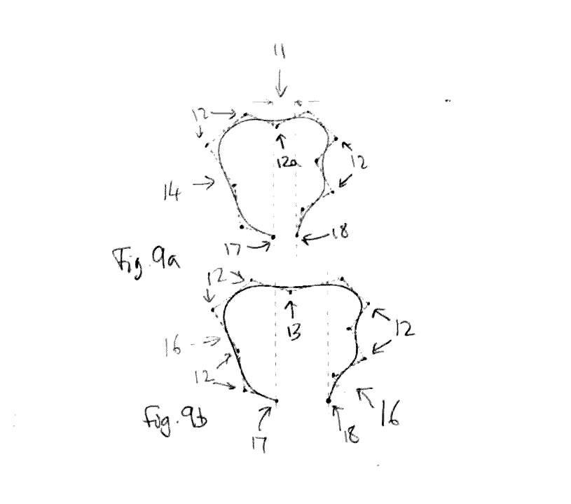

In order to address this, with the same original geometry 14, shown in FIG. 9a, scaling is only applied to control points 12a within the baseline range 11. Any control points 12 which are outside the baseline region 11 are handled on the basis that they move rigidly with the endpoints 17, 18 themselves and are not scaled, as shown in FIG. 9b. Only control point 13 has been scaled. From a comparison of the resulting geometry 15, 16 in FIGS. 8b and 9b respectively, with the original geometry 14, it can be seen clearly that the way in which scaling has been applied in FIG. 9b gives a resulting geometry 16 which better maintains the overall character of the original geometry 14 than the resulting geometry 15 in FIG. 8b. Adaptation and localisation are achieved by not uniformly scaling the whole geometric form, but only applying scaling where appropriate to maintain the overall character. More generally, whatever the constraints applied to the original freeform geometry, such as tangency requirements, or baseline range, the method of the present disclosure does not rely on a compromise, such a blending a weighted change across a series of control points, or applying a change uniformly, but is able to discriminate and apply the appropriate modification to each control point.

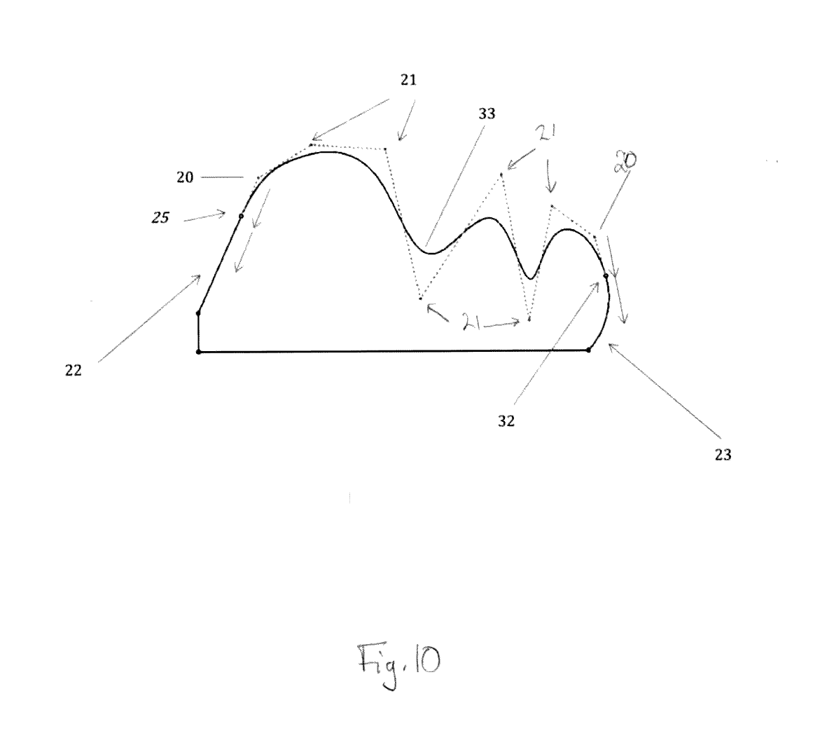

In some freeform geometry, tangent end adjustment may be required in order to maintain a tangency at the ends of the geometry. For example, as shown in FIG. 10, there is a line 22 and an arc 23 at each end of the geometry 33. Start control point 25 and end control point 32 at the ends of the geometry 33 must maintain their tangency to the neighbouring line 22, or to the arc segment 23, whereas other control points 21 to which the constraint does not apply are scaled in the normal way. The direction of the line 22 is constant. The direction of the freeform curve 33 at the start point 25 is determined by the direction between the first internal control point 20 and the start control point 25. When there is a tangency, these two directions are the same at the same point—the point of tangency. So in order to control the direction at an end (to preserve a tangency) the first internal control point 20 is moved rigidly with the start control point 25, rather than stretching it which would change the direction. Typically the end control points 25, 32 and next nearest control points 20 define the tangent direction of the geometry and therefore, in such cases, the control point 20 next to a tangency is given the same transform as the point and direction of tangency rather than being scaled. For the arc 23, or any other curve which has a varying direction, it is the direction at the end point 32 which must match for a tangency to exist. The end point 32 is a point of tangency between the freeform curve end and the arc 23. At this point the freeform geometry 33 and the arc 23 have the same direction. Other control points 21 are scaled as usual, giving the overall behaviour of shape preservation in the main with tangency preservation when required.

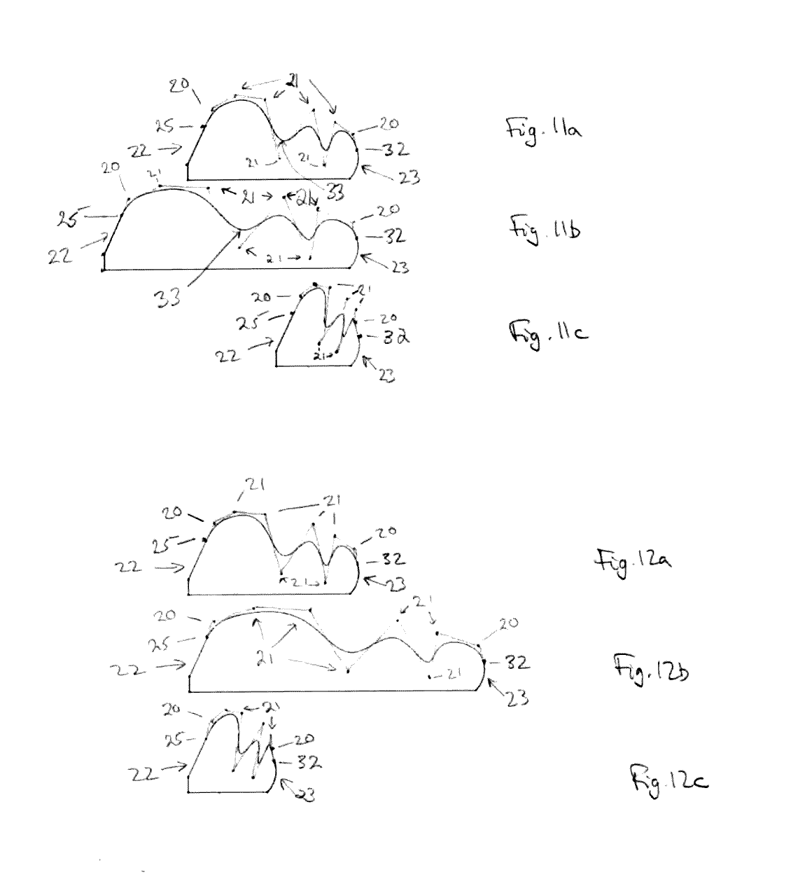

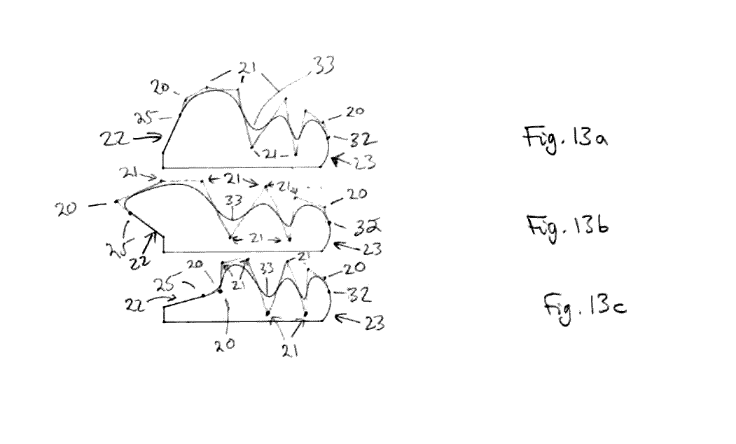

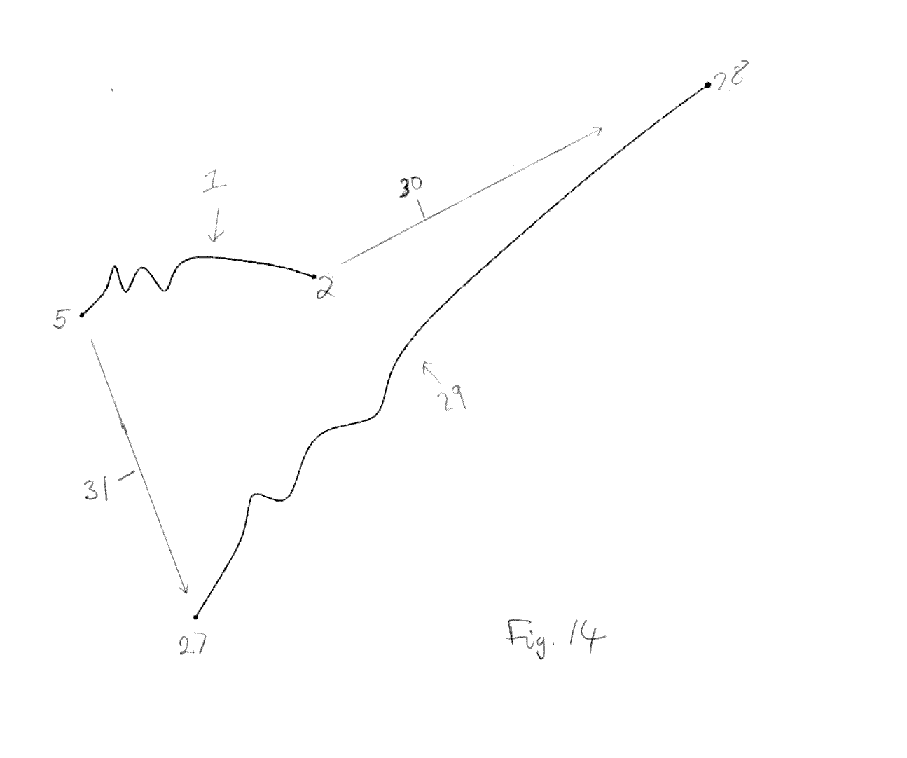

The following examples show various combinations of motion applied to the example of FIG. 10 to demonstrate how tangency is maintained when required. FIGS. 11a, 12a and 13a illustrate the starting shape of FIG. 10 and motion is applied to these. FIG. 11b shows the effect of moving a neighbouring tangent line 22 to stretch the geometry, while FIG. 11c shows the effect of moving the neighbouring tangent line 22 to compress the geometry. In both cases the overall character and tangency is maintained. The example of FIG. 12b shows the effect of moving a neighbouring tangent arc 23 to stretch the geometry and in FIG. 12c, the effect of moving the neighbouring tangent arc 23 to compress the geometry, as compared with the starting shape of FIG. 12a. In both cases overall character and tangency is maintained. For the example of FIG. 13a, the effect of rotating a neighbouring tangent line 22 to stretch the geometry is shown in FIG. 13b and the effect of rotating the neighbouring tangent line 22 to compress the geometry is shown in FIG. 13c. As with the other examples, overall character and tangency is maintained for both the stretched and compressed geometry.

In FIG. 14, an example is shown in which both the start point 5 and end point 2 are moved and a new baseline between the new start point and new end point is defined before applying the modification to the initial freeform geometry 1. Start point 5 moves as indicated by the arrow 31 to new start point 27. End point 2 moves, as indicated by the arrow 30 to new end point 28. Control points are then recalculated for the new start and end points as previously described with respect to FIGS. 2a, 3 and 4 and a new freeform geometry 29 is generated.

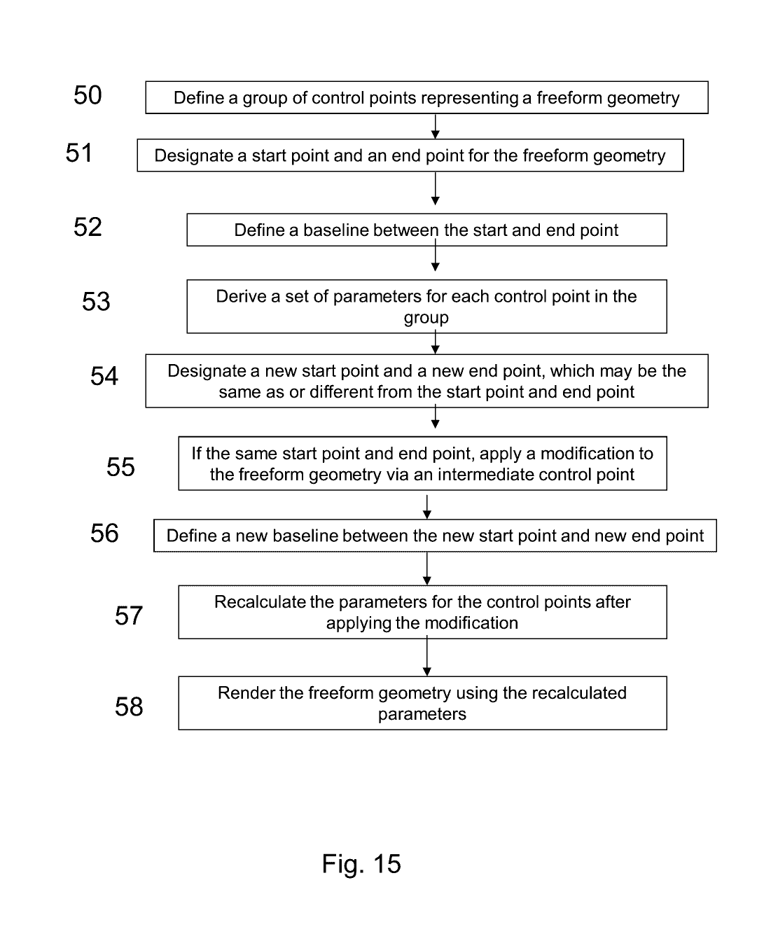

FIG. 15 is a flow diagram of the basic method of the disclosure. The first step is to define 50 a group of control points representing a freeform geometry. Within this set of control points a start point and an end point for the freeform geometry are designated 51. An initial baseline is defined 52 between the start point and end point and a set of parameters for each control point is derived 53, giving location of each control point relative to the baseline. A new start point and new end point are designated 54, typically by the user moving a control point. The new start and end points may be the same as the start point and end point used to derive the initial set of parameters, in which case, an intermediate control point is moved to apply 55 a modification to the freeform geometry, or one or both of the start point and end point may have been moved to apply the modification. For the new start point and new end point, a new baseline is defined 56. If the new start point and new end point have not actually moved, the new baseline is the same as the initial baseline. The modification is constrained by the baseline and where a projection of the control points onto the baseline occurs, whether applied via the start point, end point, or an intermediate control point, so even if the baseline does not change, the baseline information is required in order to calculate how to apply the modification to each control point of the freeform geometry. The effect of the modification when applied may be, for example, to stretch or rotate the geometry by moving one or both ends of the geometry, or stretching via one of the control points, if the start point and end point are fixed. Applying the modification requires recalculating 57 the set of parameters for the modified control points and/or the modified start point or end point and then rendering 58 the freeform geometry with the modification applied.

The techniques described above, or hereinafter, may be used in simulating modifications to construction of a multi-part product by modelling the product using a model and selecting one part of the multi-part product comprising a freeform geometry to which the techniques may be applied. When the user has made the necessary modifications to individual geometries, then a representation of the modified part or product in which the geometries exist may be made and if required, tests may be applied to check that the new geometry meets any operational or manufacturing criteria. When satisfied with the result, changes to the geometry may be saved for future use, such as for conversion to a suitable format to provide instructions for manufacturing a part, or to manufacture a mould to form the part.

In the tangency example given above, control points close to the ends are treated differently to the way that other control points are treated, even when a defined modification is nominally to be applied to the complete freeform geometry. The examples above have been described with respect to one or both of the start point and end point being moved to apply the modification to the geometric form. However, it is equally possible that the start and end points both remain the same and a control point which is neither a start point, nor an end point, is moved to apply a stretch to the geometric form. Thus, the principle of treating certain control points differently for a given defined modification may be expanded on to give further control of end conditions such as continuity order, or curvature matching, by increasing the number of control points that are not stretched at the ends, or by other types of special handling of these control points at or close to the ends of the geometry, such as applying a modification to these points which is different to the modification defined and applied to the remainder of the control points.

Another example is to apply a stretch from one end and treat the other end as an out of bounds segment. For example, if one end were fixed and a mid range control point moved, the control points between the fixed and moved point may be stretched, but those on the other side of the moved point may be moved rigidly with the moving mid range control point, in a similar way to the treatment of control points in FIGS. 9a and 9b which fall outside the new baseline.

In a further example, a stretch may be applied from one end by moving the start point or the end point and the end which is not moved to initiate the stretch also stretches as a consequence. Thus, all of the control points are stretched, rather than some maintaining a fixed position relative to the fixed start or end point.

The method of this disclosure provides the user with the ability to apply stretch and rotate behaviour to a freeform geometry to achieve a result which preserves the overall shape of the starting geometry, preserves end shape for out of bounds regions and preserves end tangency. Starting from a given original geometry and defined new end points, irrespective of whether only one or both of the new start and end points are different from the original start and end points, the method does not suffer hysteresis and so is reversible and repeatable. The method may be applied to 2d curves, 3d curves and surfaces.

Of course, those of skill in the art will recognize that, unless specifically indicated or required by the sequence of operations, certain steps in the processes described above may be omitted, performed concurrently or sequentially, or performed in a different order.

Those skilled in the art will recognize that, for simplicity and clarity, the full structure and operation of all data processing systems suitable for use with the present disclosure is not being depicted or described herein. Instead, only so much of a data processing system as is unique to the present disclosure or necessary for an understanding of the present disclosure is depicted and described. The remainder of the construction and operation of data processing system 41 may conform to any of the various current implementations and practices known in the art.

It is important to note that while the disclosure includes a description in the context of a fully functional system, those skilled in the art will appreciate that at least portions of the mechanism of the present disclosure are capable of being distributed in the form of instructions contained within a machine-usable, computer-usable, or computer-readable medium in any of a variety of forms, and that the present disclosure applies equally regardless of the particular type of instruction or signal bearing medium or storage medium utilized to actually carry out the distribution. Examples of machine usable/readable or computer usable/readable mediums include: nonvolatile, hard-coded type mediums such as read only memories (ROMs) or erasable, electrically programmable read only memories (EEPROMs), and user-recordable type mediums such as floppy disks, hard disk drives and compact disk read only memories (CD-ROMs) or digital versatile disks (DVDs).

Although an exemplary embodiment of the present disclosure has been described in detail, those skilled in the art will understand that various changes, substitutions, variations, and improvements disclosed herein may be made without departing from the spirit and scope of the disclosure in its broadest form.

None of the description in the present application should be read as implying that any particular element, step, or function is an essential element which must be included in the claim scope: the scope of patented subject matter is defined only by the allowed claims. Moreover, none of these claims are intended to invoke 35 USC §112(f) unless the exact words “means for” are followed by a participle.

1. A method of modifying a freeform geometry, the method comprising:
defining a group of control points representing the freeform geometry;
defining an initial baseline between a start point and an end point of the freeform geometry;
deriving an initial set of parameters for each control point to represent an initial location of the control point relative to the initial baseline;
choosing a new start point and a new end point for a modified freeform geometry;
defining a new baseline between the new start point and the new endpoint;
applying a modification to the freeform geometry;
deriving a recalculated set of parameters for each of the control points to provide a representation of a new location of the control point, relative to the new baseline, for the applied modification; and,
rendering the modified freeform geometry using the recalculated set of parameters.

2. The method according to claim 1, wherein the initial set of parameters for each control point are derived from a relative distance of the control point along the initial baseline and an absolute distance of the control point from the initial baseline.

3. The method according to claim 1, wherein the recalculated set of parameters for each control point have the same relative location along the new baseline as the original parameters had along the initial baseline.

4. The method according to claim 1, wherein the recalculated set of parameters have a same absolute distance from the new baseline, as the absolute distance of the control point from the initial baseline.

5. The method according to claim 1, wherein the new start point is at the same location as the start point.

6. The method according to claim 1, wherein the new end point is at the same location as the end point.

7. The method according to claim 1, wherein the method further comprises selecting a series of new end points, each at a constant distance from the new start point.

8. The method according to claim 1, wherein the method further comprises selecting a series of new end points each at a different distance from the new start point.

9. The method according to claim 1, wherein the method further comprises selecting a control point and applying the modification to the freeform geometry via the control point.

10. The method according to claim 1, wherein the method further comprises:
defining a range of locations on the baseline between the start point and end point;
determining whether any control point projects onto the baseline outside the range; and
only applying a modification to control points which fall within the range.

11. The method according to claim 1, wherein the method further comprises:
determining whether a start or end point is tangent to a neighbouring curve; and
applying a different modification to the first internal control point.

12. The method according to claim 1, wherein the method further comprises applying a modification to control points which are separated from a start point, an end point, a tangent line, or tangent arc by more than one other control point.

13. The method according to claim 1, wherein the method further comprises applying a different modification to the start point, the end point, or control points which are not separated from the start point, or end point by more than one other control point.

14. A data processing system comprising at least a processor and accessible memory to implement a method of modifying a freeform geometry, the system configured to:
define a group of control points representing the freeform geometry;
define an initial baseline between a start point and an end point of the freeform geometry;
derive an initial set of parameters for each control point to represent an initial location of the control point relative to the initial baseline;
choose a new start point and a new end point for a modified freeform geometry;
define a new baseline between the new start point and the new endpoint;
applying a modification to the freeform geometry;
derive a recalculated set of parameters for each of the control points to provide a representation of a new location of the control point, relative to the new baseline, for the applied modification; and,
render the modified freeform geometry using the recalculated set of parameters.

15. The system according to claim 14, wherein the system comprises a store, or display configured to output a topology of a product comprising the modified freeform geometry.

16. The system according to claim 15, wherein the system is configured to provide a representation of the topology of the product comprising instructions for manufacture.

17. A non-transitory computer-readable medium encoded with executable instructions that, when executed, cause one or more data processing systems to perform a method of simulating modifications to construction of a multi-part product the method comprising:
modelling the product using a model;
selecting one part of the multi-part product comprising a freeform geometry;
defining a group of control points representing the freeform geometry;
defining an initial baseline between a start point and an end point of the freeform geometry;
deriving an initial set of parameters for each control point to represent an initial location of the control point relative to the initial baseline;
choosing a new start point and a new end point for a modified freeform geometry;
defining a new baseline between the new start point and the new endpoint;
applying a modification to the freeform geometry;
deriving a recalculated set of parameters for each of the control points to provide a representation of a new location of the control point, relative to the new baseline, for the applied modification; and,
rendering the modified freeform geometry using the recalculated set of parameters; and,
providing a representation of the modified product.
